(19) United States
(12) Patent Application Publication
(10) Pub. No.: US 2005/0248436 A1
(43) Pub. Date: Nov. 10, 2005

(54) Programmable, eletronic, keyless entry, key fob signal receiver, storage and transmission device for multiple vehicles

(76) Inventors: Richard Alan Hohmann, Jacksonville, IL (US); Kathlene Hohmann Bissell, Ponte Vedra Beach, FL (US)

Correspondence Address: Richard Alan Hohmann;The Hohmann Agency, 1850 W. Morton Ave., Jacksonville, IL, 62650, US

(21) Appl. No.: 11/123,777

(22) Filed: May 5, 2005

Related U.S. Application Data
(60) Provisional application No. 60/569,813, filed on May 10, 2004.

(51) Int. Cl. H04B 1/00

(52) U.S. Cl. 340/5.72; 340/825.69; 340/825.72; 340/426.13

(57) ABSTRACT

The invention is a programmable device that can receive signals from remote keyless entry transmitters for keyless entry vehicle systems commonly offered as either standard or optional equipment on most new cars and trucks; that can select which vehicle's signals to store; that can be programmed to receive and store the different and discrete locking, unlocking, truck unlocking/opening and horn alarm (panic) signals, one at a time, from different multiple vehicles; that will allow selection of a specific vehicle to signal; that will transmit the locking, unlocking, truck unlocking and horn alarm signals from the programmable device for each vehicle selected on demand; that has the programming function, switches to select vehicle, receivers, memory and transmitting devices for receiving, storing and transmitting to multiple vehicles, all contained in a single, remote, keyless entry, key fob. A key fob is commonly a chain or ring or decorative device that holds an item such as a key. However, recently, the key fob has also been a remote keyless entry transmitter offered as either standard or optional equipment on most new cars and trucks. The keyless entry key fob may also contain an actual physical vehicle key or keys attached to the key fob on a ring or chain.

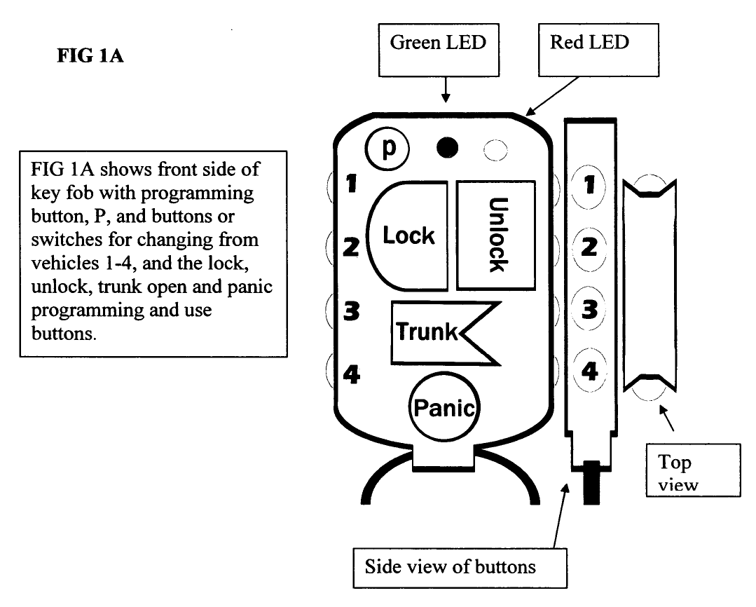

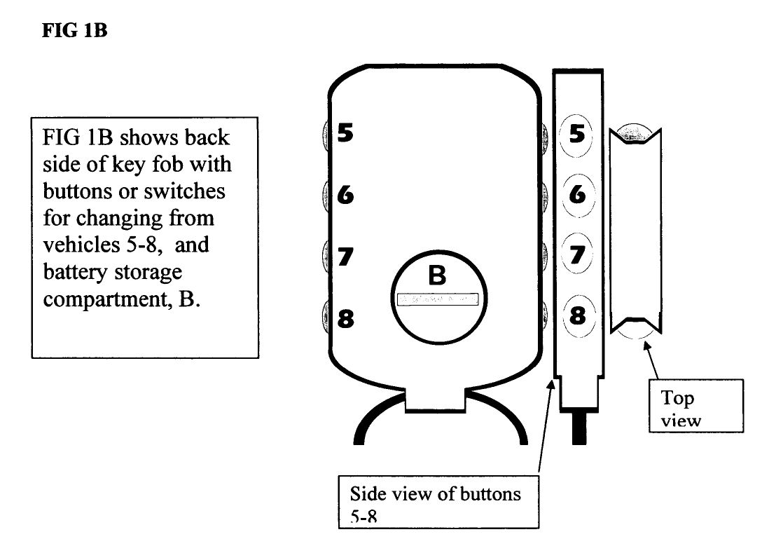

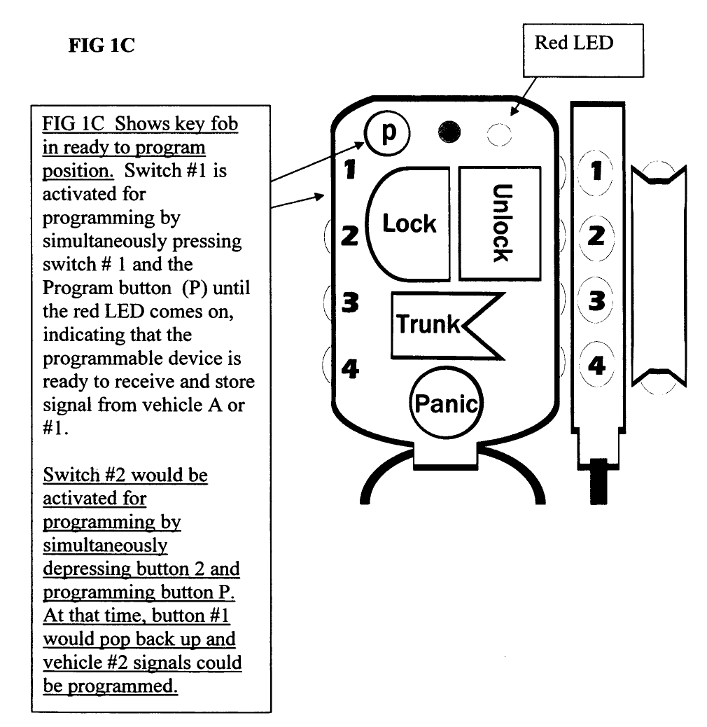

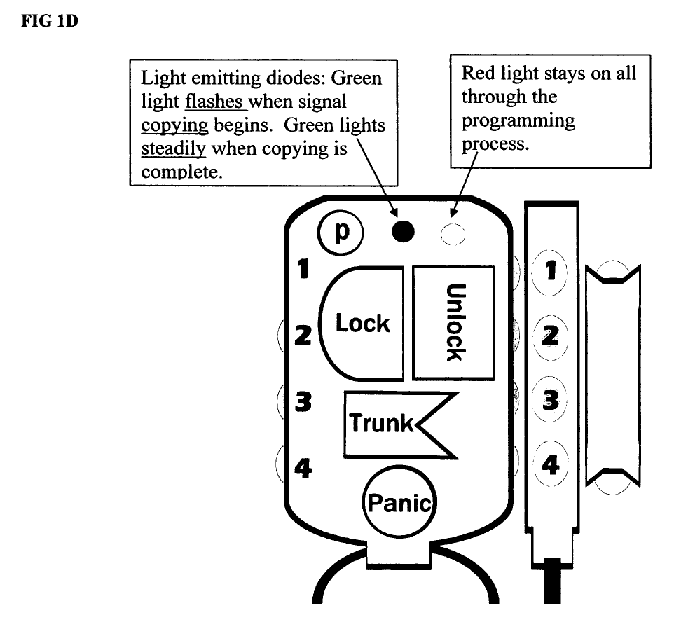

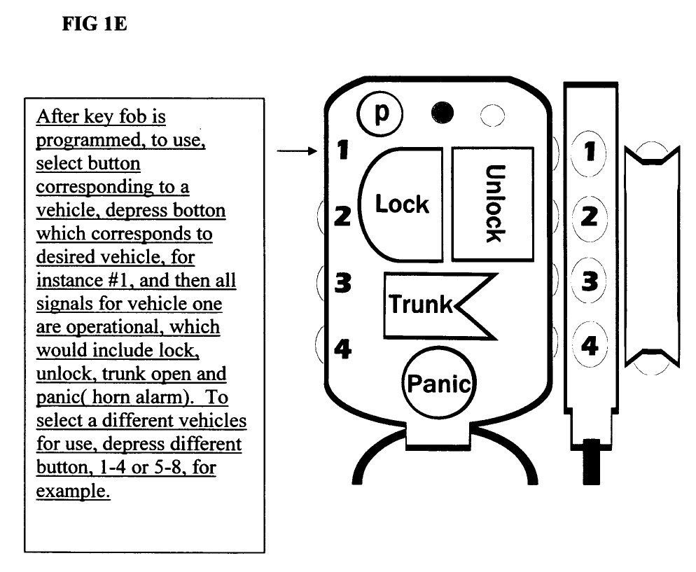

### CROSS-REFERENCE TO RELATED APPLICATIONS

There are no known prior nonprovisional utility patent applications copending. This is a continuation of provisional patent application 60/569,813. This application, however, utilizes intellectual property from U.S. Pat. Nos. 6,703,941; 5,864,297; 5,699,055; 5,686,903; 4,794,268;

### FEDERAL FUNDS WERE INVOLVED IN THIS INVENTION

Not Applicable

### SEQUENCE LISTING, TABLE OR COMPUTER PROGRAM LISTING

Not Applicable

### BACKGROUND OF THE INVENTION

1. Field of the Invention

The field of the invention is Communications: Electrical. The invention is classed in the field of controlling one or more devices to obtain a plurality of results by transmission of a designated one of plural distinctive control signals over a smaller number of communication lines or channels than the total number of possible distinct results. The invention is further classed as being that in which the communication line includes transmission and reception of an electromagnetic wave, in which the communication line includes transmission and reception of an electromagnetic wave and wherein authorization control data stored in a controller (e.g., lock) is defined or modified in response to a received code from a data bearing record or carrier.

2. Description of Related Art

Electronic keyless entry systems to lock and unlock doors, unlock trunks and command a horn alarm for individual vehicles exist. They exist in a key fob size. U.S. Pat. No. 4,794,268 dealt with automotive keyless entry systems with a pocket portable radio signal transmitter. Currently, each vehicle comes with its own specifically programmed key fob.

Trainable transmitters can learn and store an RF frequency signal, such as garage door opening signals as in U.S. Pat. No. 6,703,941, U.S. Pat. No. 5,686,903, and U.S. Pat. No. 5,699,055.

Radio frequency storage and transmission devices that receive and transmit signals to open and close garage doors exist. Devices with the ability to program and store and retransmit garage door radio frequency signals in vehicle rear view mirrors and/or vehicle roof panels exists. Trainable transmitters can learn and store an RF frequency signal, such as garage door opening signals as in U.S. Pat. No. 6,703,941, U.S. Pat. No. 5,686,903, and U.S. Pat. No. 5,699,055.

Key fobs can now be reprogrammed to learn and store and save new signals to unlock and lock car doors, open trunks and sound car horns. The capability to reprogram a remote keyless entry system in a key fob for a single vehicle is covered in U.S. Pat. No. 5,864,297.

### SUMMARY OF THE INVENTION

Currently, vehicle owners must currently carry a separate key fob to operate the door lock and unlock and the trunk open and horn alarm. This results in situations where individuals may be carrying two or three or more different key fobs at once in order to be sure to have the appropriate device for the vehicle they wish to use. It is a clumsy method and takes up a great deal of space in pocket or purse.

The programmable, electronic, keyless entry, key fob, signal receiver, storage and transmission device solves the dilemma of carrying multiple key fobs by storing the signals for multiple vehicles in one key fob or similar device by use of a switch that allows signals to be programmed from vehicle A into a discrete electronic location in the key fob as well as for vehicle B in another discrete electronic location, and for vehicle C in another, and so forth, up to as many signals as can easily be stored with electronics that can be easily carried in pocket or purse.

To change from using Vehicle A to Vehicle B, the vehicle owner would push a button on the programmable, electronic, keyless entry, key fob signal receiver, storage and transmission device for multiple vehicles which would act as a switch to tell the key fob to switch from using signals for Vehicle A to signals for Vehicle B, and so on, depending on how many vehicle signals are stored in one key fob or similar hand-held/pocket-sized device.

Electronic keyless entry systems to lock and unlock doors, unlock trunks and command a horn alarm for individual vehicles exist. Radio frequency storage and transmission devices that receive and transmit signals to open and close garage doors exist. Devices with the ability to program and store and retransmit garage door radio frequency signals in vehicle rear view mirrors and/or vehicle roof panels exists.

Having a programmable, electronic, keyless entry, key fob, signal receiver, storage and transmission device, with the ability to program signals from several vehicles would be a significant improvement in terms of convenience to owners of multiple vehicles.

It should not be necessary to have vehicle models from the same manufacturer in order to programmed the programmable, electronic, keyless entry, key fob, signal receiver, storage and transmission device.

Security needs and insurance needs may require the programming to be done at a vehicle dealer. However, these social and business decisions are outside the scope of the invention itself.

The programmable, electronic, keyless entry, key fob signal receiver, storage and transmission device for multiple vehicles utilizes technology that is commonplace today in several different inventions. Many vehicles now have the ability to store garage door opener signals—in fact more than one garage door plus private gate signal—in a vehicle mirror or roof console or other location in a vehicle. That storage device also has the technology to transmit signals, making it unnecessary to keep the OEM garage door and/or gate door opener itself in the vehicle.

The actual programming of the vehicle garage door transmitter can be done by the vehicle owner or operator, and the steps are usually outlined in the owner's manual for the vehicle. Usually, the two devices are held near each other and the signal button from the garage door opener is pressed while a button on the receiving device in the vehicle mirror or roof panel is also pressed. While this happens, a light emitting diode may flash from the signal receiver in the rear view mirror or roof panel to indicate that the garage door signal is stored. After the garage door open/close signal is stored, the garage door can opened or closed by pushing the appropriate button on the rear view mirror or roof panel instead of the OEM garage door opener.

Recently, a reprogrammable keyless entry key fob was invented, taking the technology of storing the lock, unlock trunk open and horn alarm out of the hands of the vehicle dealer and putting it in the hands of consumers. The reprogrammable keyless entry system saves and stores and allows retransmission of lock, unlock, trunk unlock/open and horn alarm signals. This was invented because of the cost and inconvenience of replacing lost key fobs.

This invention allow vehicle owners the freedom to carry less with them and to freely change between use of vehicles without carrying many key fobs with them at all times.

The programmable, electronic, keyless entry, key fob signal receiver, storage and transmission device for multiple vehicles combines technology that is used for other purposes into a new key fob that will allow signals from more than one vehicle to be programmed, stored and signaled on command to the appropriate vehicle.

The programmable, electronic, keyless entry, key fob, will allow a vehicle user to:
select a vehicle.
   store vehicle signals for unlock, lock, trunk open, horn alarm for that vehicle in the programmable, electronic, keyless entry, key fob for multiple vehicles
select a vehicle
   store vehicle signals for unlock, lock, trunk open, horn alarm for that vehicle in the programmable, electronic, keyless entry, key fob for multiple vehicles
select a different vehicle
   store vehicle signals for unlock, lock, trunk open, horn alarm for that vehicle in the programmable, electronic, keyless entry, key fob, etc., for as many vehicles as a key fob design will reasonably accommodate
select any vehicle with signals stored in the programmable, electronic, keyless entry, key fob for multiple vehicles
   and then unlock, lock, trunk open, horn alarm for the selected vehicle using the programmable, electronic, keyless entry, key fob for multiple vehicles instead of only using the OEM supplied keyless entry system.
select the next vehicle with signals stored in the programmable, electronic, keyless entry, key fob,
   and then unlock, lock, trunk open, horn alarm for the selected vehicle, using the programmable, electronic, keyless entry, key fob for multiple vehicles instead of only using the manufacturer's supplied keyless entry system, etc. for as many vehicles as a key fob design will reasonably accommodate
   and so on, so that drivers of multiple vehicles—such as families with several cars—can access several personal vehicles by carrying only one programmable, electronic, keyless entry, key fob signal receiver, storage and transmission device for multiple vehicles instead of carrying a group of keyless entry key fobs, one for each vehicle.

Vehicle users would still need to carry the ignition “key” to start the vehicle.

While the invention has been shown and described with reference to a particular embodiment, it will be understood by those skilled in the art that various changes in form and details may be made without departing fro the spirit and scope of the invention.

1. A programmable, electronic, keyless entry, key fob, signal receiver, storage and transmission device:
that receives a signal from a transmitter such as an original equipment manufacturer (OEM) key fob
that stores the OEM signal and saves it
that is capable of retransmitting said signal with the same characteristics to remotely activate multiple operations of a device, such as car door unlocking, car door locking, trunk opening and/or horn blowing in a vehicle

2. A programmable, electronic, keyless entry, key fob, signal receiver, storage and transmission device:
that can be programmed to save and retransmit signals from OEM device A to remotely activate multiple operations of a device, such as car door unlocking, car door locking, trunk opening and/or horn blowing in a vehicle A
that can be programmed to save and retransmit signals from OEM device B to remotely activate multiple operations of a device, such as car door unlocking, car door locking, trunk opening and/or horn blowing in a vehicle B
that can be programmed to save and retransmit signals from OEM device C to remotely activate multiple operations of a device, such as car door unlocking, car door locking, trunk opening and/or horn blowing in a vehicle C
that can be programmed to save and retransmit signals from OEM device D to remotely activate multiple operations of a device, such as car door unlocking, car door locking, trunk opening and/or horn blowing in a vehicle D
that can be programmed to save and retransmit signals from OEM device E to remotely activate multiple operations of a device, such as car door unlocking, car door locking, trunk opening and/or horn blowing in a vehicle E
that can be programmed to save and retransmit signals from OEM device F to remotely activate multiple operations of a device, such as car door unlocking, car door locking, trunk opening and/or horn blowing in a vehicle F
that can be programmed to save and retransmit signals from OEM device G to remotely activate multiple operations of a device, such as car door unlocking, car door locking, trunk opening and/or horn blowing in a vehicle G
that can be programmed to save and retransmit signals from device OEM H to remotely activate multiple operations of a device, such as car door unlocking, car door locking, trunk opening and/or horn blowing in a vehicle H
all in one unit, with the limit of signals received and stored and retransmitted being that which can fit into a key fob or similar object hand-held object

3. A programmable, electronic, keyless entry, key fob, signal receiver, storage and transmission device:
that compartmentalizes and separates storage of signals from OEM device A (which may be a key fob) such as a vehicle A door unlock, lock, trunk open and horn alarm from storage of said signals for OEM device B,C,D,E,F,G,H, and so on such as in vehicle B,C,D,E,F,G,H door unlock, lock, trunk open and horn alarm and so on

4. A programmable, electronic, keyless entry, key fob, signal receiver, storage and transmission device:
that has a switch to change from receiving and storing signals from OEM device A such as vehicle A door unlock, door lock, trunk unlock and horn alarm to OEM device B to OEM device C to OEM device D to OEM device E to OEM device F to OEM device G to OEM device H, and so on,

5. A programmable, electronic, keyless entry, key fob, signal receiver, storage and transmission device:
that has a switch to cause transmission of signals to remotely activate multiple operations of vehicle A such as door unlock, door lock, trunk unlock and horn alarm
that has a switch to cause transmission of signals to remotely activate multiple operations of vehicle B such as door unlock, door lock, trunk unlock and horn alarm
that has a switch to cause transmission of signals to remotely activate multiple operations of vehicle C such as door unlock, door lock, trunk unlock and horn alarm
that has a switch to cause transmission of signals to remotely activate multiple operations of vehicle D such as door unlock, door lock, trunk unlock and horn alarm
that has a switch to cause transmission of signals to remotely activate multiple operations of vehicle E such as door unlock, door lock, trunk unlock and horn alarm
that has a switch to cause transmission of signals to remotely activate multiple operations of vehicle F such as door unlock, door lock, trunk unlock and horn alarm
that has a switch to cause transmission of signals to remotely activate multiple operations of vehicle G such as door unlock, door lock, trunk unlock and horn alarm
that has a switch to cause transmission of signals to remotely activate multiple operations of vehicle H such as door unlock, door lock, trunk unlock and horn alarm
and so on,to switch to cause transmission to as many vehicles as may be conveniently stored in the key fob.

6. A programmable, electronic, keyless entry, key fob, signal receiver, storage and transmission device:
that after being programmed to full capacity can be reprogrammed to accept new signals up to the capacity of the unit, for example, replacing signals for OEM device A ( which may be a key fob) with signals for OEM device J, and signals for OEM device B with signals for OEM device K, etc.

7. A programmable, electronic, keyless entry, key fob, signal receiver, storage and transmission:
that signals start and completion of storage of signals from OEM device A ( which may be a key fob), such as vehicle A door unlock, door lock, trunk unlock and horn alarm by blinking LED lights to let programmer know signals are stored
that signals start and completion of storage of signals from OEM device B, OEM device C, OEM device D, OEM device E, OEM device F, OEM device G, OEM device H, and so on by blinking LED lights to let user know that signals are stored.

8. A programmable, electronic, keyless entry, key fob, signal receiver, storage and transmission device:
that may store signals such as for vehicle A door unlock by placing Original Equipment Manufacturer ( OEM) transmission device A ( which may be a key fob) near programmable, electronic, keyless entry, key fob, signal receiver, storage and transmission key fob and pressing door unlock button of both OEM device A and of programmable, electronic, keyless entry, key fob, signal receiver, storage and transmission device, thereby activating signal transmission from OEM device A ( which may be a key fob) key fob, until LED blinking pattern on LED on programmable, electronic, keyless entry, key fob, signal receiver, storage and transmission device indicates signal for OEM device A ( which may be a key fob) door unlock is stored.
that stores signals such as for vehicle A door lock by placing Original Equipment Manufacturer ( OEM) transmission device A ( which may be a key fob) near programmable, electronic, keyless entry, key fob, signal receiver, storage and transmission key fob and pressing door lock button of both OEM device A and of programmable, electronic, keyless entry, key fob, signal receiver, storage and transmission device, thereby activating signal transmission from OEM device A ( which may be a key fob) key fob, until LED blinking pattern on LED on programmable, electronic, keyless entry, key fob, signal receiver, storage and transmission device indicates signal for OEM device A ( which may be a key fob) door lock is stored.
that stores signals such as for vehicle A trunk open by placing Original Equipment Manufacturer ( OEM) transmission device A ( which may be a key fob) near programmable, electronic, keyless entry, key fob, signal receiver, storage and transmission key fob and pressing trunk open button of both OEM device A and of programmable, electronic, keyless entry, key fob, signal receiver, storage and transmission device, thereby activating signal transmission from OEM device A ( which may be a key fob) key fob, until LED blinking pattern on LED on programmable, electronic, keyless entry, key fob, signal receiver, storage and transmission device indicates signal for OEM device A ( which may be a key fob) trunk open is stored.
that stores signals such as for vehicle A horn alarm by placing Original Equipment Manufacturer ( OEM) transmission device A ( which may be a key fob) near programmable, electronic, keyless entry, key fob, signal receiver, storage and transmission key fob and pressing horn alarm button of both OEM device A and of programmable, electronic, keyless entry, key fob, signal receiver, storage and transmission device, thereby activating signal transmission from OEM device A ( which may be a key fob) key fob, until LED blinking pattern on LED on programmable, electronic, keyless entry, key fob, signal receiver, storage and transmission device indicates signal for OEM device A ( which may be a key fob) horn alarm is stored.
that stores signals in a similar manner for OEM device B-H, and so on such, for vehicles B-H and so on.
